(19) United States
(12) Patent Application Publication
(10) Pub. No.: US 2005/0132494 A1
(43) Pub. Date: Jun. 23, 2005

(54) Medical sanitary multifunctional system bed

(76) Inventor: Masateru Koga, Machida-shi (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(21) Appl. No.: 10/739,335

(22) Filed: Dec. 19, 2003

(51) Int. Cl. A61G 7/02; A61G 7/008

(52) U.S. Cl. 5/605; 5/607; 5/606

(57) ABSTRACT

Disclosed is a medical sanitary multifunctional system bed for nursing having necessary functions which can be added optionally according to clinical conditions of users and hence, it can be supplied at a lower cost. The optional addition of functions allows the medical sanitary multifunctional system bed to perform necessary functions case by case thereby minimizing economical burdens on patients. Ordinarily, it is provided with a lower capsule supported by a metallic supporting frame, an upper capsule mounted on the lower capsule, a movable and rotatable portion, which is supported by the metallic supporting frame and a plurality of removable cushions placed on the movable portion. On a optional basis, the bed includes a stool, bath tub, shower and washers.

### BACKGROUND OF THE INVENTION

Description of the Prior Art

As widely known, there is a need for nursing by attending persons when any persons suffer diseases and become too serious in condition to move freely. To suit the need, beds for nursing have been spread substantially with convenient functions for facilitating the nursing of patients. Representative functions so far arranged for the beds for nursing are, for example, frame bodies that are used for fixing patients to help them turn on their sides in bed, tables used for meals, toilets to be set under the bed bodies, washers and the like. Shower sets and bath sets are also functions very helpful for patients so feeble to be confined to beds.

However, regrettable to say, the beds for nursing with such convenient functions have been very costly unavoidably because of production on a small lot basis and furthermore, the prices of the beds have been inevitably higher to accommodate the types of functions included. Hence, with more functions, the beds for nursing become often so higher in prices and can not be purchased by those who truly wish to use.

It should be noted that the clinical conditions are highly varied among the patients who need the beds for nursing and in most cases, the functions needed are different individually. But in the conventional beds, the types of functions included are not specified in details and can not be used unless payments are made even for the prices of functions not to be used.

For example, toilet sets under the beds are functions which are not needed before patients are confined to the beds and so, the functions are unnecessary for the patients able to walk to the toilets. Likewise, shower sets, bath sets or the like are surely useful as functions but at present, these functions have been purchased considering expected use in future rather than the need for the current use. Thus, up to the present, in some cases, payments must have been reluctantly made even for unnecessary functions.

### SUMMARY OF THE INVENTION

This invention is made in light of the problems as mentioned above. It is an object of the invention to propose a bed which makes all necessary functions available by adding the functions according to clinical conditions of bed users and to supply the bed at as lower costs as possible.

The above object of the present invention is achieved by a medical sanitary multifunctional system bed which has various functions effective for the nursing of patients hard to move own bodies freely, fairly aged persons so feeble to be confined to the beds and the like and the body of which is constituted of a bed for supporting the upper half body of a user, a waist bed for supporting the center part of the user and an upper half body support bed for supporting the upper half body of the user. The body of the bed is rotatably mounted on a bed base and is so arranged as to allow the mounting of an upper hot water washer at an upper part of the bed for supporting the upper half body, of a lower hot water washer and a lower flush toilet to be disposed under the waist bed and of an upper half body support body used for changing the position of the user on the upper half body support bed.

On the other hand, a portion of a cushion of the waist bed is made removable so that the lower hot water washer and the lower flush toilet are disposed to make the flush toilet usable.

There are several other features. The flush toilet includes a crushing means comprising a crushing cutter and a motor as a crushing means for crushing and discharging excrement of the user, the body of the bed is rotatably mounted on the bed through a rotating support shaft while being made rotatable by a specified angle in a specified direction with a rotation controller and a water tank is provided to store hot water to be supplied to the upper and lower hot water washers while a cord heater is wound on a hose for the supply of hot water with which the hot water stored in the water tank is supplied to the upper and lower hot water washers.

Because of the techniques and means as mentioned above of the present invention, it is possible to provide a bed for nursing which has functions only necessary for the patients and the fairly aged persons who use the bed and the bed itself can be supplied at lower costs.

### BRIEF DESCRIPTION OF THE DRAWINGS

FIG. 1 shows a general plan view showing an embodiment according to the present invention.

FIG. 2 is a view illustrating a P portion in FIG. 1.

FIG. 3 is a perspective view showing an example of a bed base.

FIG. 4 is a sectional view showing an example of a lower flash toilet to be disposed under a waist bed.

FIG. 5 is a sectional view showing an example of a water tank.

FIG. 6 is a view showing an example of the waist bed properly changed in form.

FIG. 7 is another view showing an example of the waist bed properly changed in form.

FIG. 8 is a view showing an example of an upper lid body properly changed in form.

FIG. 9 is a view showing an example of a lower bed properly changed in form.

FIG. 10 is another view showing an example of the lower bed properly changed in form.

FIG. 11 is a perspective view showing an example of the upper lid body properly changed in form.

FIG. 12 is a view showing an example of a bed properly changed in form.

FIG. 13 is a view showing how to use a body support frame.

FIG. 14 is a perspective view showing an example of the upper lid body properly changed in form.

FIG. 15 is a perspective view showing an example of the medical sanitary system bed having an handy bed type housed into the water tank.

FIG. 16 is a view showing an example of the handy bed type housed into the water tank.

FIG. 17(F) is a perspective view of the medical sanitary multifunctional system bed showing an embodiment according to the present invention.

FIG. 17(A) is a part of a view illustrating the state in which the body of the bed and a tray for transferring a patient or like are transferred relatively according the present invention.

FIG. 17(C) is another part of a view illustrating the state in which the body of the bed and the tray for transferring a patient or like are transferred relatively according to the present invention.

FIG. 18(A) is an enlarged view of the right side of the view 17 (C).

FIG. 18(B) is a view for describing the front of the view 18 (A).

FIG. 19 is a perspective view illustrating the state in which a patient takes a meal. Shown on the left is a mobile type upper washer.

FIG. 20 is a perspective view illustrating the state in which a patient is sleeping. (the rotation controller for preventing bed sores is in operation)

### DETAILED DESCRIPTION OF THE INVENTION

Preferred embodiments according to the present invention will be described in detail with reference to accompanying drawings.

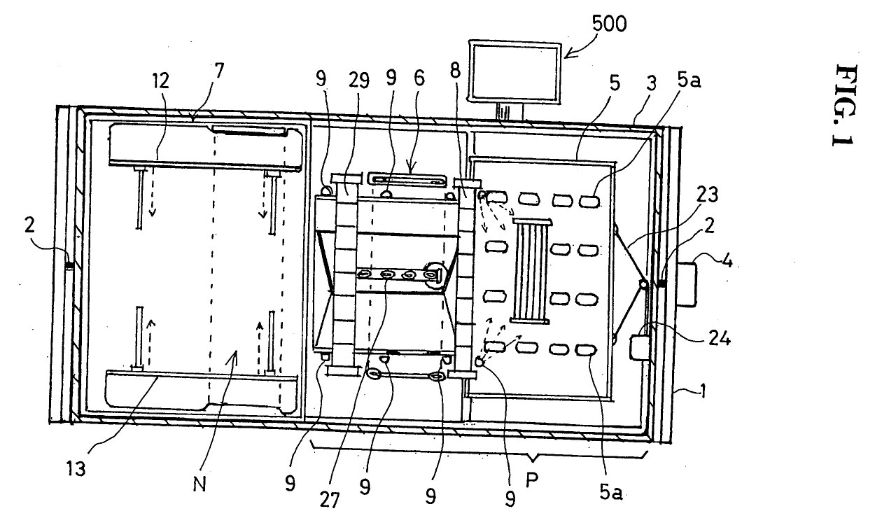

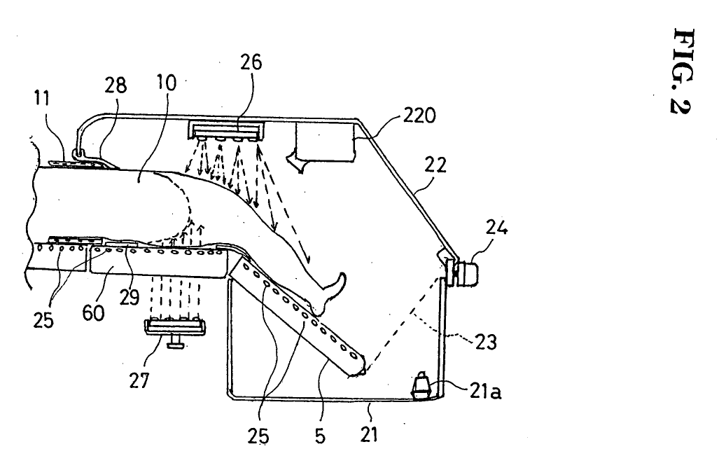

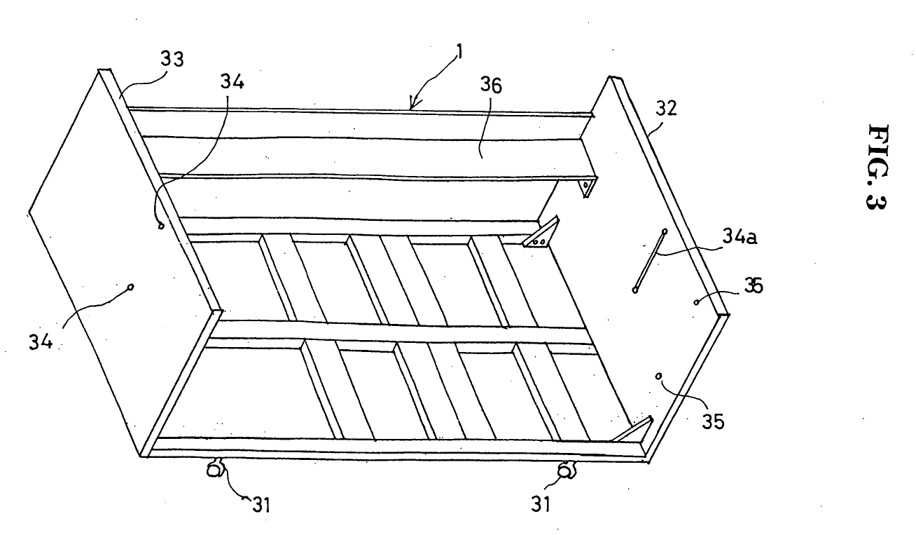

Referring first to FIG. 1, FIG. 2 and FIG. 3, two each of hinge holes 34 for rotatably supporting a rotation support shaft 2 are formed vertically at the center parts on both sides of a bed base 1, a hinge 34a is mounted on the hinge holes 34 and with a rotation controller 4 on the hinge 34a, the body 3 of the bed is mounted on the bed base 1. In the form of the embodiments, the rotation controller 4 comprising a motor, a reduction gear and the like is provided to accomplish the rotation of the body 3 of the bed without requiring so large forces and the position of the rotation controller 4 mounted on the hinge 34a can be selected vertically to allow the selection of the height positions of the body 3 of the bed freely. For example, the position is lowered in the normal operation and during the use of the flush toilet, it is raised for the user confined to the bed thereby significantly improving the handling of the body 3 of the bed.

The bed base 1 in the embodiments is provided with a string-hoisting bed 5, a waist bed 6, an upper half body support bed 7 and the like and the waist bed 6 and the string-hoisting bed 5 are made foldable mutually to be connected with a bed connection cover 8, which prevents a danger of getting the user's body caught in the folded portion when the string-hoisting bed 5 is lifted or lowered. In FIG. 1, the string-hoisting bed 5 and the waist bed 6 shown as a zone P are divided to let the lower half body of the user be washed as illustrated by a side view of FIG. 2 and include a lower water tank 21, an upper 11d body 22, a string 23 for hoisting, a motor 24 for hoisting with a string for lifting or lowering the string-hoisting bed 5 and the like. Several draining holes 5a are formed in the string-hoisting bed 5.

As shown in FIG. 2, a cord heater 25 is arranged for the cushion 60 part of the waist bed 6 to keep the user 10 warm moderately so that the body of the user 10 wetted under washing can be dried completely. An air heater 220 is mounted on an upper lid body 22 to get the wetted body under the use of an upper hot water washer 26 dried. The cushion 60 part of the bed also can be dried by the above-mentioned methods and for example, the cushion 60 part may be made detachable freely through a velcro thereby enabling quick replacement of the wet one with dry one 60.

The upper hot water washer 26 is mounted on the upper lid body 22 and a lower hot water washer 27 is mounted below the position of the hip of the user 10. In the form of the embodiments, an example shows one-side opened arrangement of the cushion. The body of the user 10 is washed by hot water discharged to the user 10 in a shower from the upper and lower hot water washers 26 and 27. A water shielding cover 28 is mounted at an end part of the upper lid body 22 to prevent washing hot water from scattering over the upper half body of the user 10 while his lower half body is being washed. The water shielding cover 28 is formed out of a rubber or a vinyl-based synthetic resin. In FIG. 2, there is shown an example that a cord heater-applied belly band 11 is mounted on the belly part of the user 10 to keep the user 10 warm while shielding the part from water. In order to support the body of the user 10 with the lower portion thereof opened as seen therein, a waist support belt 29 is disposed on the waist bed 6.

To drain the water accumulated on the bottom part of the lower water tank 21, an underwater pump 21a is disposed and when the hot water discharged to the user 10 from the upper hot water washer 26 is accumulated within the lower water tank 21, it is pumped up and drained with the underwater pump 21a to eliminate such a trouble as an overflow of the lower water tank 21, eventually getting the inside of a room wetted where the bed is placed.

As shown in FIG. 1, a plurality of upper bed washing nozzles 9 are arranged to wash portions between the user 10 and the waist bed 6 and so, none of them is used except when the user 10 becomes so feeble to be confined to the bed.

Both on the left and right sides of the upper half body support bed 7, upper half body supporting bodies 12 and 13 are disposed and made slidable approaching each other to match the size of the user 10. When the upper half body support bodies 12 and 13 thus arranged according to the embodiments are used, the upper half body support bodies 12 and 13 are fixed at specified positions determined to match the width of the body and then, with a blanket or the like thereon, the user 10 is fastened on the bed with a belt so that the user 10 is supported and kept from falling down from the bed when the bed is inclined so as to prevent possible bedsore.

Various types of beds are considerable. One example is shown in FIG. 3. As illustrated in FIG. 3, the bed base 1 in the form of the embodiments has casters 31 for moving mounted at a lower part thereof.

As previously stated, upper and lower vertical plates 32 and 33 are provided respectively with hinge holes 34 which are used for moving the rotating support shaft 2 vertically when the bed is rotated. A lock hole 35 for fixing the bed is formed in the upper vertical plate 32. An auxiliary bed 36 is attached on one side along the length of the bed base 1 to increase the effective bed width for the bed not rotated.

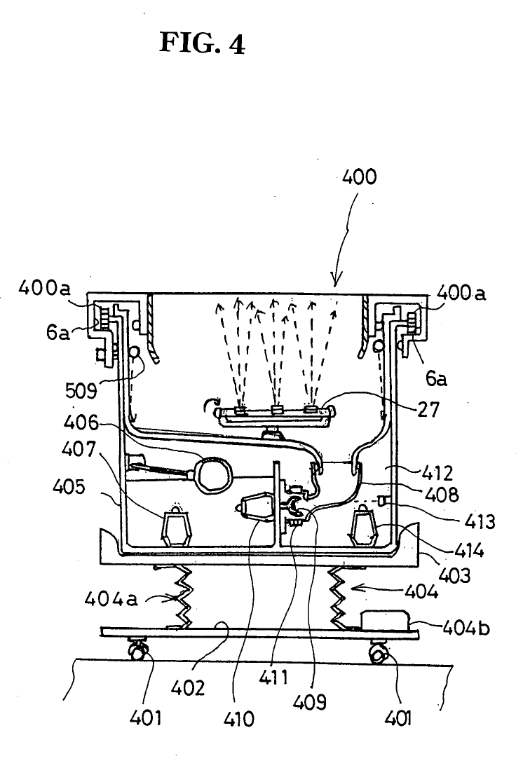

Referring to FIG. 4, a lower flush toilet 400 is described. The lower flush toilet 400 is disposed under the waist bed 6 in FIG. 1 as required and at the lower end part thereof, a rotary roller 400a is disposed within an engaging part 6a provided on the waist bed 6 to guide the lower flush toilet 400 to a specified position under the waist bed 6.

On the other hand, casters 401 for moving are disposed on the underside of a base plate 402 provided at a lower part of the lower flush toilet 400 to allow it to be pulled out from under the waist bed 6 simply in the cleaning or the repairing thereof. A support base 403 is mounted on the base plate 402 through an air support mechanism 404, which is provided to support the weight of above washing water tank 405 when it is filled with water. In the form of the embodiments, an example shows the air support mechanism constituted of a bellows 404a and a compressor 404b.

A ball tap 406 is mounted in the washing water tank 405 and moves vertically depending on washing water stored in the washing water tank 405 so that water is supplied into the washing water tank 405 from a water supplying pipe according to the position thereof. The washing water stored in the washing water tank 405 is pumped up with the underwater pump 407 to be supplied to the lower hot water washer 27.

On the other hand, a crushing chamber 408 is provided to receive hot water discharged from the lower hot water washer 27 and excrement discharged from the user 10 and a crushing cutter 409 is disposed to crush solid matters being rotated with the motor 410 of the crushing chamber 408. The filth crushed by the crushing cutter 409 is accumulated in a sewage chamber 412 through a dirt filter 411 disposed at the lower end part of the crushing chamber 408 and when the liquid in the sewage chamber 412 reaches a specified level, the level is detected with a float switch 413. When the float switch 413 detects the level reaching the specified level, it activates an underwater pump 414 to discharge the sewage outside.

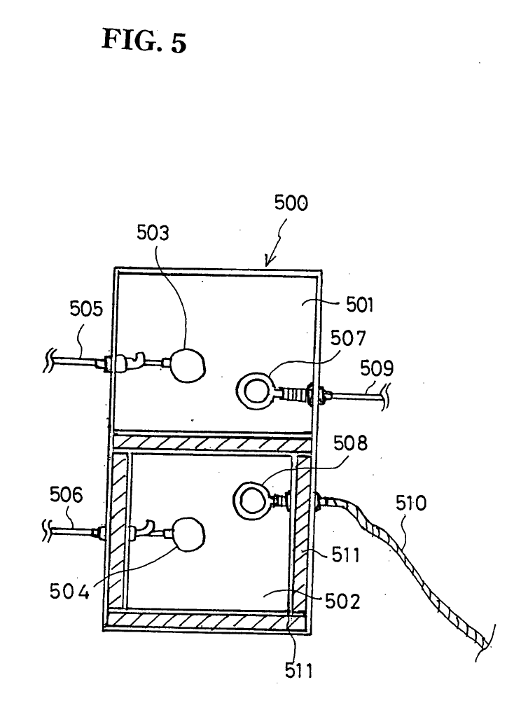

Referring to FIG. 5, a water tank 500 is described. The water tank 500 in the form of the embodiments is built up of a resin or steel and has a cold water layer 501 and a hot water layer 502. Ball taps 503 and 504 are arranged respectively in the cold water layer 501 and the hot water layer 502 and restrict water and hot water to be supplied through water resistant hoses 505 and 506 to reach specified levels. Underwater pumps 507 and 508 are arranged respectively in the cold water layer 501 and the hot water layer 502 and the underwater pump 507 in the cold water layer 501 supplies cold water to the lower flush toilet 400 through a hose 509 to be used for washing the filth. The hot water pumped up with the underwater pump 508 is supplied to the hot water washers 26 and 27 through a hose 510 for the supply of hot water. As in the form of the embodiments, this can separate the utilization of the hot water from the utilization of the cold water to prevent useless consumption of the hot water thereby reducing required expenses. The underwater pump 508 disposed in the hot water layer 502 supplies hot water to the upper and lower hot water washers 26 and 27 through the hose 510 for the supply of hot water wound with the cord heater. In the form of the embodiments, a heat insulating material is arranged in the wall surface of the hot water layer 502 while the hot water is supplied through the hose 510 for the supply of hot water wound with the cord heater so that the hot water is prevented from being cooled in the hose 510 for the supply of hot water.

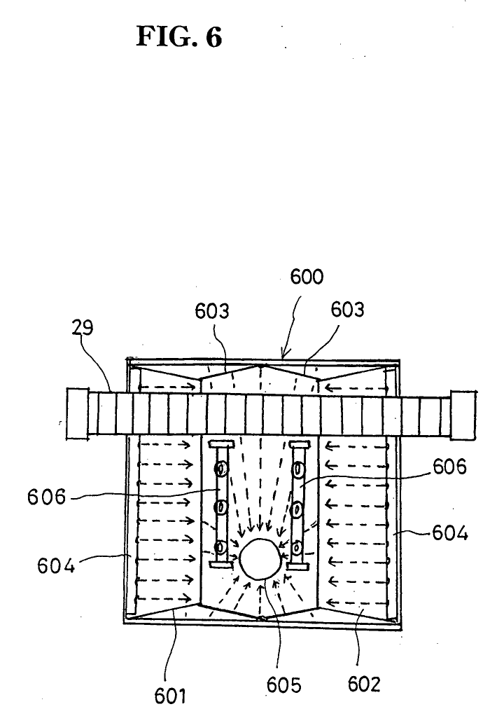

Thus, the hot water can be supplied being kept hot constantly in the operation to prevent a possible trouble of cooling the hot water down in the hose 510 for the supply of hot water when it is supplied to the user 10. Referring to FIG. 6, the example of the waist bed 6 properly changed in form is described. A waist bed 600 in the form of the embodiments is so arranged that cushions 601 and 602 are opened both to the left and right. The opening or closing of the cushions 601 and 602 is done by an opening-closing control string 603, which is pulled by the rotation of a motor not illustrated to move the cushions to the normal positions at which the user lies on his side or the positions at which the cushions serve as a toilet seat for discharging excrement. To wash on the surfaces of the cushions 601 and 602, hot water pipes 604 are arranged along both left and right sides thereof and hot water flowing out of the hot water pipes 604 runs on the surfaces of the left and right cushions 601 and 602 as indicated by the dotted line in FIG. 6. The cushions 601 and 602 can be built by placing the cushions containing a heater for warming on a stainless plate or a hard synthetic resin. In the example shown in FIG. 6, a lower washer 606 is arranged being divided on the left and the right of a crushing chamber 605 and the hot water which is discharged from the lower washer 606 and washes the user is guided to the crushing chamber 605.

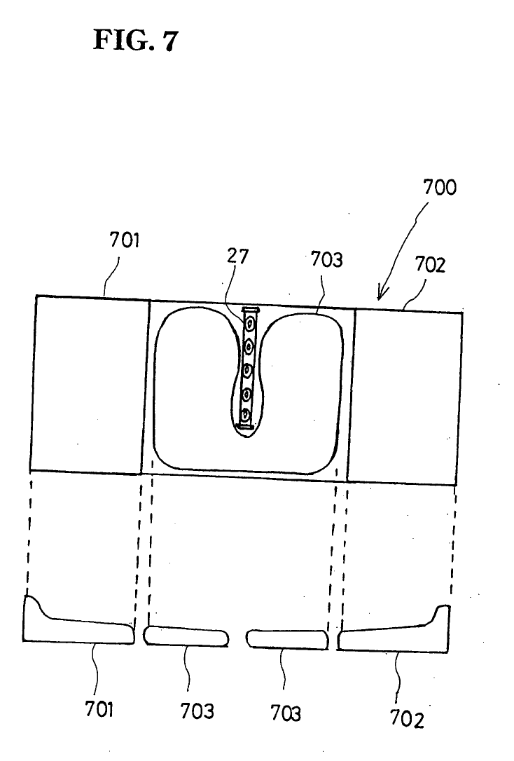

FIG. 7 shows the example of the waist bed 6 properly changed in form. A waist bed 700 has left and right cushions 701 and 702 arranged on the left and right areas thereof and a body waist/hip cushion 703 is disposed between the left and right cushions 701 and 702. The body waist/hip cushion 703 is formed into a shape that allows the supporting of the hip part of the user 10 when he sits thereon and is cut off at the central part thereof to facilitate the washing of the local part of the user 10 by the hot water discharged from the lower hot water washer 27.

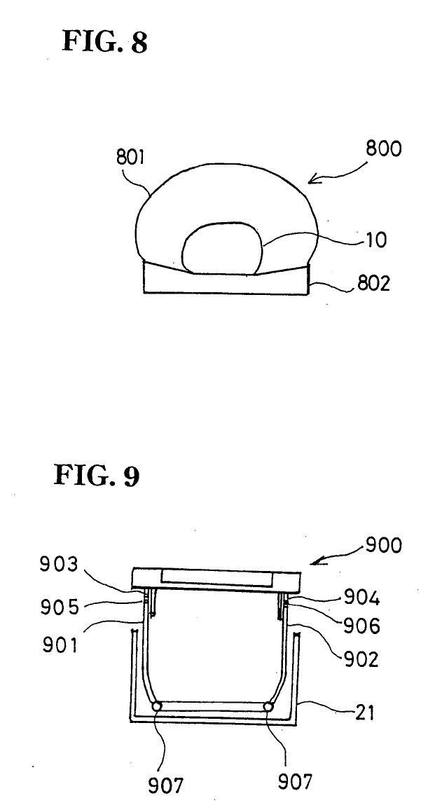

Referring to FIG. 8, the example of the upper lid body 22 properly changed in form is described. An upper lid body 800 shown in FIG. 8 is an example in which a capsule formed in a semicircle surrounding the waist part of the user 10 is arranged on a bed 802. The bed 802 is built higher on both sides thereof than the central part thereof so that water dropped on the bed is gathered to the central part to run downward from the central part.

FIG. 9 shows an example of the lower part of the string-hoisting bed 5 properly changed in form. As in FIG. 9, in the example, curtains 901 and 902 for preventing the scattering of water are disposed both on left and right sides on the underside of a bed 900. The curtains 901 and 902 for preventing the scattering of water are detachably mounted on protruded pieces 903 and 904 arranged projecting downward from both left and right sides on the underside of the bed 900 through fasteners 905 and 906 and can be removed freely for cleaning under the bed 900.

Strings 907 are mounted respectively at lower end parts of the curtains 901 and 902 for preventing the scattering of water to regulate the interval therebetween 901 and 902 with the strings 907 while preventing the curtains 901 and 902 from being stuck on the lower water tank 21.

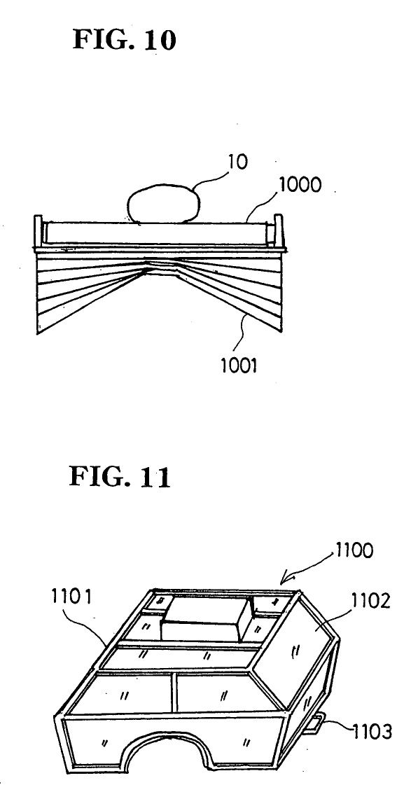

FIG. 10 shows an example of the connection changed in form between a bed 1000 and the lower water tank 21 (not illustrated). In the example, a bellows type curtain 1001 for preventing the scattering of water is disposed on the underside of the bed 1000. In the case of the example, water dropping from the bed 1000 is prevented from scattering into the room to be gathered into the lower water tank 21 accurately.

Referring to FIG. 11, the example of the upper lid body 22 properly changed in form is described. In an upper lid body 1100 in the example, a box-like framework 1101 is built up of steel or the like and a transparent body 1102 made of a synthetic resin is disposed thereon 1101 and one side end thereof is mounted on the bed through a hinge mechanism (not illustrated) while a knob 1103 is mounted on the other side end part thereof and held to open or close the transparent body.

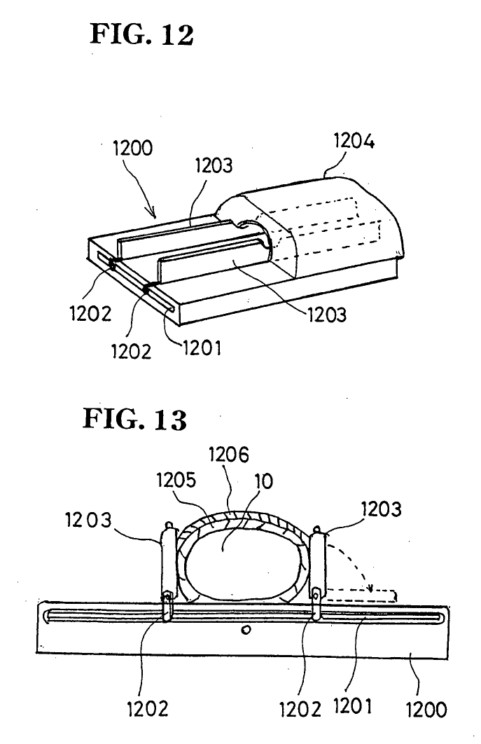

FIG. 12 is a perspective view showing the example of the upper half body support bed. In the example shown in FIG. 12, rails 1201 for moving are installed respectively on the front and rear sides of a bed 1200 across the width thereof and sliders 1202 are slidably disposed on the respective rails 1201. Body support frames 1203 are mounted on the sliders 1202 while an upper washer 1204 is mounted on the bed 1200.

FIG. 13 is a view for describing how the body supporting frames 1203 are used. As shown in FIG. 13, the body supporting frames 1203 are slid to contact the user 10 sufficiently. As mentioned above, the body supporting frames 1203 sufficiently contacting the user 10 firmly support the user 10 when the bed 1200 is inclined to help the user turn on his side in bed. In FIG. 13, the numeral 1205 indicates a blanket and 1206 a body supporting belt.

FIG. 14 is a perspective view of another arrangement of the upper lid body 22. An upper lid body 1400 is constituted of first and second upper lid bodies 1401 and 1403 which are openably mounted separately on the side parts of a bed 1403. In this manner, the division of the upper lid body simplifies the handling thereof as compared with the integral formation thereof.

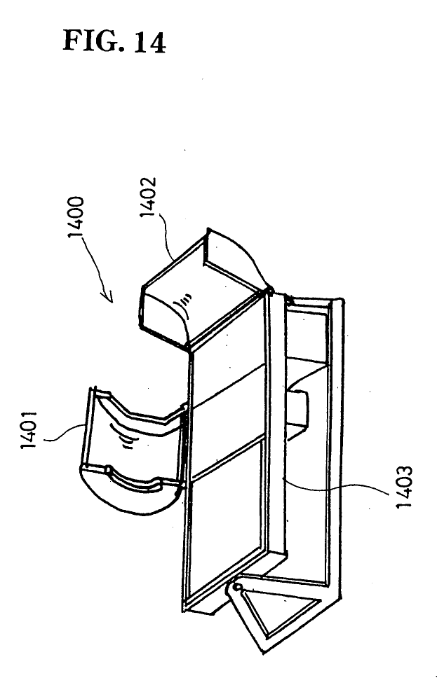

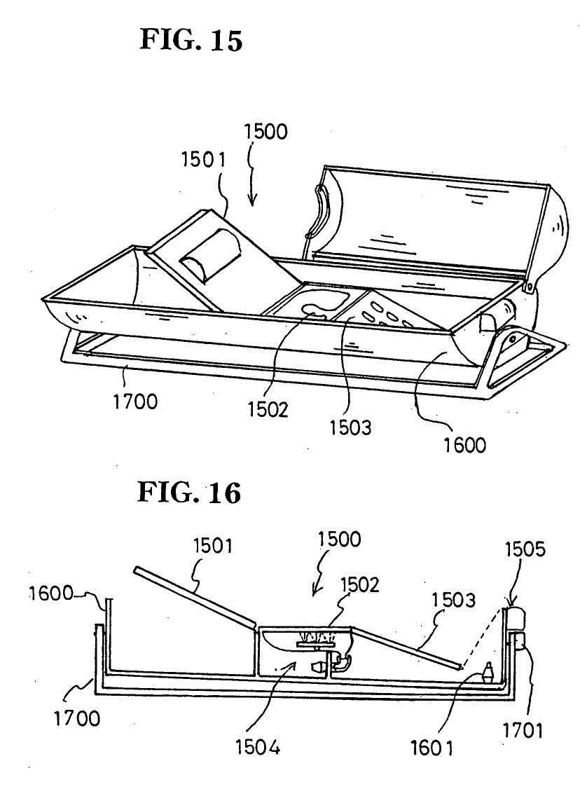

Based on FIGS. 15 and 16, the example of a handy bed type is described. As illustrated, in the example, a handy bed type 1500 is housed into a water tank 1600. The handy bed type 1500 comprises a bed 1501 for the upper half body, a bed 1502 for the waist part and a bed 1503 for leg parts which are foldable freely individually.

The water tank 1600 is rotatably supported on a support base 1700 and a turning mechanism 1701 (motor 1701 is shown representing the turning mechanism in FIG. 16) is actuated to turn the water tank by arbitrary angles. A lower flush toilet 1504 as mentioned above is disposed below the bed 1502 for the waist part. The bed 1503 can be set at arbitrary angles with a hoisting mechanism 1505. In addition, an underwater pump 1601 is arranged within the water tank 1600 to discharge the sewage accumulated in the water tank 1600 outside.

In the medical sanitary multifunctional system bed, as previously stated, the present invention provides a unique structure of adding various functions separately onto the body of the bed and so, the user can select necessary functions to build a bed in which functions truly required are arranged systematically. This can eliminate the disadvantage for the user due to extra payments for unreasonably higher prices as a result of unnecessary functions included.

For example, when the user becomes too feeble to walk to toilets down from the bed, the lower flush toilet 400 is attached under the bed. If this is possible, the users who are able to walk to toilets can obtain system beds at prices which can be lowered just by the cost equivalent to that of the lower flush toilet 400. In order to be attached additionally, the flush toilet under the bed is detachably built, hence offering an advantage of facilitating cleaning and maintenance thereof.

In addition to the flush toilet under the bed, additional functions available as required according to the present invention are an upper body washer, a bed rotation aid for preventing possible bedsore, shower and bath sets and the like. The system bed provided integrally with all of the functions may be very costly. But selective addition of the necessary functions as seen in the system bed in the form of the embodiments makes it possible to obtain a system bed having the necessary functions at as lower costs as possible.

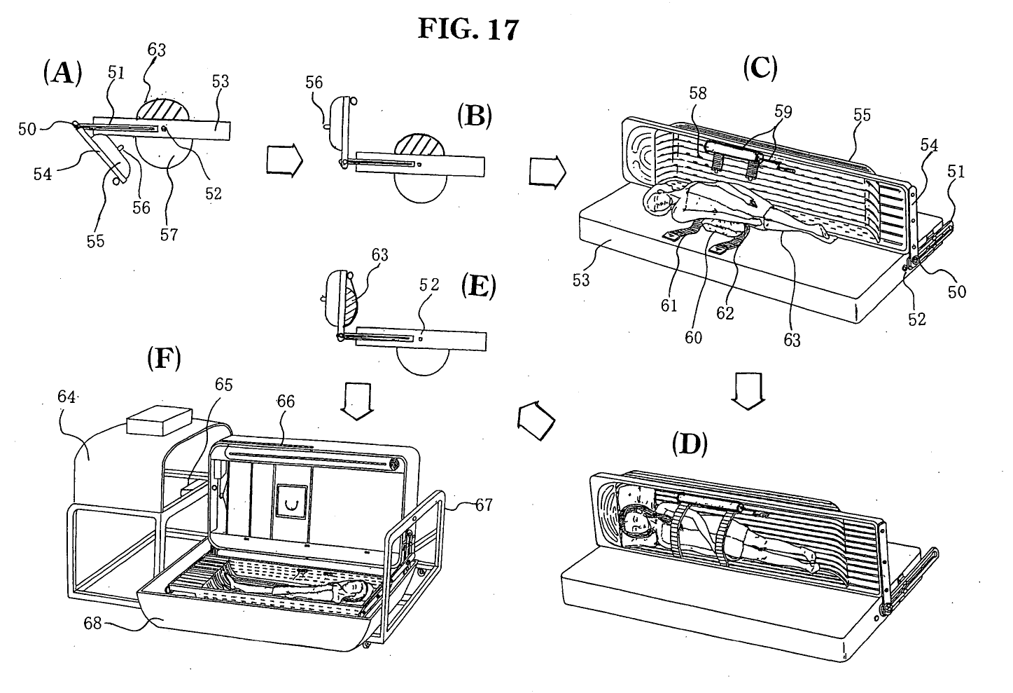

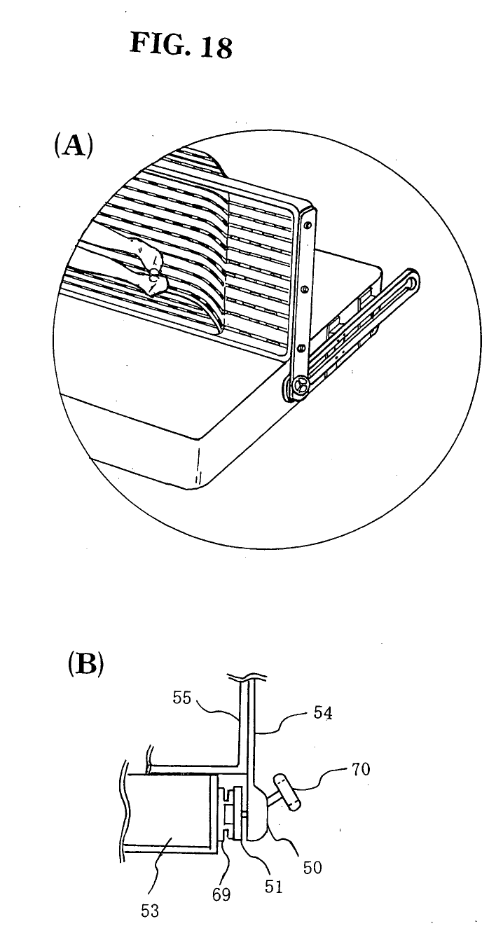

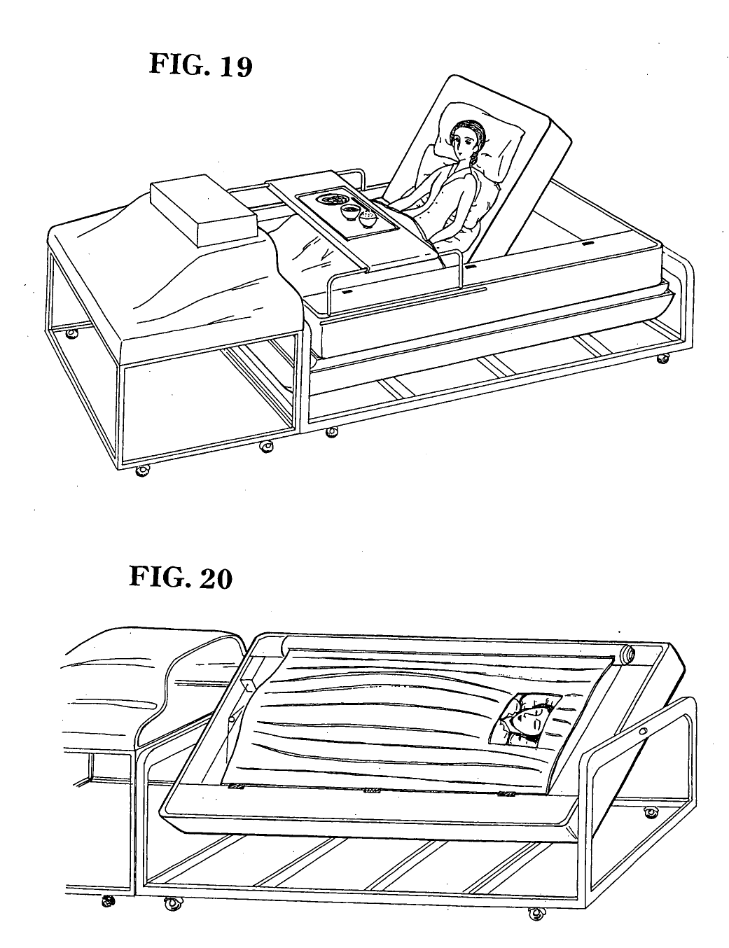

(A), (B), (C), (D), (E) and (F) of FIG. 17 show an example of the invention for a bath and how to take a bath. Description is made in the order of (A) to (F). The numeral 53 in the drawing (A) indicates the cushion part of the bed on the outside of which a frame (not illustrated) made from wood, aluminum, steel or the like is applied. The bed (cushion parts) is turned with a hinge 52 and automatically controlled. Rails, indicated at 51, are arranged parallel side by side on the front and rear sides of the frame on the cushion of a rotary bed and a gear and a lock mechanism are provided within a rotation fixing device, indicated at 50.

A bath tray, indicated at 55, for bathing is normally folded under the body of the bed so as not to disturb the use of the body 53 of the bed and is moved only when the patient takes a bath. The bath tray 55 in the drawing (A) is moved to the position as indicated in the drawing (B) when turned by 225 with the rotation fixing device 50. When the bath tray at the position as indicated in the drawing (B) is pushed manually by an attending person with a knob, indicated at 56, it is shifted to the position as indicated in the drawing (C). The rotation fixing device is locked, a cushion such as Japanese cushion is placed beneath the patient 63 being kept lifting a bit to let belts 61 and 62 pass and then, the body of the patient is fixed with a belt winding device, indicated at 59, which is operable manually or electrically.

When the rotation fixing device 50 in the drawing (D) is unlocked and the bath tray is transferred to the tip of the rails, the body of the user and the bath tray reach the position as indicated in the drawing (E). As the bed is turned slowly by 90 with a bed rotation controller 65 in the drawing (F), the bath tray enters into a bath tub and hot water flows thereinto through numerous holes (50 or the like) to cover the bath tray. Then, the belts are taken off to make the patient take a bath. Thus, the present invention facilitates the taking care of the patient in a bath. The patient is transferred back onto an upper part of the bed by following the reverse prodecure relative to the one as metioned above.

In the present invention, the body of the bed is constituted of the bed for supporting the lower half body of the user, the waist-bed for supporting the central part of the user and the upper half body of the user and is rotatably mounted on the bed base while being so arranged to allow the mounting of the upper hot water washer at an upper part of the bed, of the lower hot water washer and the lower flush toilet under the waist bed and of the upper half support body used for changing the position of the user on the upper half body support bed, which makes it possible to provide a bed with functions alone necessary for the user. As a result, a medical sanitary multifunctional system bed with required functions only can be supplied at lower costs. The optional addition of the necessary functions allows the building of medical sanitary multifunctional system beds to match the clinical conditions of the user. This enables the providing of beds for nursing which have the functions necessary to the minimum but sufficient for the nursing of patients and fairly aged persons unavoidably confined to the beds. Furthermore, in the present invention, the cord heater is wound on the hose for the supply of hot water for supplying hot water stored in the water tank to prevent possible trouble of supplying the hot water chilled, namely cooled water to the user early in the operation thereby allowing the user to be supplied with comfortable hot water constantly.

1. A medical sanitary multifunctional system bed with functions effective for the nursing of patients hard to move their bodies freely, fairly aged persons so feeble to be confined to beds, wherein the body 3 thereof is constituted of a bed 5 for supporting the lower half body of a user 10, a waist bed 6 for supporting the central part of the user 10 and an upper half body support bed 7 for supporting the upper half body of the user 10 and is rotatably mounted on a bed base 1 while being so arranged to allow the mounting of an upper hot water washer 26 on the bed 5, of a lower hot water washer 27 and a lower flush toilet 400 under the waist bed 6 and of upper half body supporting bodies 12 to be used for changing the position of the user 10 on the upper half body support bed 7.

2. The medical sanitary multifunctional system bed as claimed in claim 1, wherein a part of the cushions of the waist bed 6 is made removable so that the lower hot water washer 27 and the lower flush toilet 400 are disposed under the bed to allow the using of a flush toilet.

3. The medical sanitary multifunctional system bed as claimed in claim 3, wherein the lower flush toilet 400 includes a crushing means comprising a crushing cutter 409 and a motor 410 as a crushing means for crushing and discharging excrement of the user 10.

4. The medical sanitary multifunctional system bed as claimed in claim 1, wherein the body 3 of the bed is rotatably mounted on the bed base 1 through a rotating support shaft 2 while being made rotatable by a specified angle in a specified direction with a rotation controller 4.

5. A medical sanitary multifunctional system bed as claimed in claim 2, wherein a water tank 500 is provided to store hot water which is supplied to the upper hot water washer 26 and the lower hot water washer 27 while a cord heater is wound on a hose 510 for the supply of hot water for supplying the hot water stored in the water tank 500 to the upper hot water washer 26 and the lower hot water washer 27.

6. The medical sanitary multifunctional system bed as claimed in claim 1, wherein equipment is built to allow a patient or the like to take a bath in an external bathtub by using a tray 55 for transferring the patient or the like so arranged as to be movable parallel almost to the central part from a side end part of the body of the bed.
